(19) United States
(12) Patent Application Publication
(10) Pub. No.: US 2004/0080643 A1
(43) Pub. Date: Apr. 29, 2004

(54) Layout for a line image sensor

(76) Inventor: Fang-Chin Peng, Hsinchu City (TW)

Correspondence Address: BIRCH STEWART KOLASCH & BIRCH, PO BOX 747, FALLS CHURCH, VA, 22040-0747, US

(21) Appl. No.: 10/687,882

(22) Filed: Oct. 20, 2003

(30) Foreign Application Priority Data
Oct. 21, 2002 (TW) 091216831

(51) Int. Cl. H04N 3/14

(52) U.S. Cl. 348/294

(57) ABSTRACT

The present invention discloses a layout for a line image sensor utilizing an interlacing structure, which a plurality of pixels are arranged into several rows and each pixel in the row is interlacing with other two pixels in another row respectively in space. The present invention can raise the resolution of the line image sensor.

### FIELD OF THE INVENTION

The invention generally relates to a layout for an image sensor, especially for a layout for a line image sensor.

### BACKGROUND OF THE INVENTION

In general, the image sensor divides into two types, line type and area type, having different purposes. The area image sensor mainly uses for digital camera, digital video camera and action detector, while the line image sensor mainly uses for bar-code reader and scanner. There are two fabricating technologies of the image sensor: Charge-Couple Device (CCD) and Complementary Metal-Oxide Semiconductor (CMOS). On the market development, the image sensors of CCD technology are currently at the first place, while the image sensors of CMOS have the developing trend of surpassing the image sensors of CCD technology in the future.

However, no matter CCD or COMS technology, both adopt the framework of the FIG. 1 in the layout for the line image sensor. Please refer to FIG. 1, the line image sensor 10 has a pixel arranging structure that arranges all pixels 12 in a straight line, which the width (including the gap 14) of each pixel is “d” and the special gap 14 between each pixel. Therefore, the numbers of the pixels and the width of the pixel “d” determine the length of the line image sensor 10. The layout seems easy while a problem of longer length of the sensor raises, when higher resolution is requested, namely, more pixels (for example 1024 pixel points). Moreover, the yield rate will decrease in the chip fabrication because of the longer length in one direction.

### SUMMARY OF THE INVENTION

According to the problems of the prior art, the present invention provides a layout for a line image sensor to achieve the goal of higher resolution in the current technological limitation.

To achieve the above goal, the present invention provides a layout for a line image sensor, having the following features: the line image sensor is formed by a plurality of pixels being arranged in two pixel rows to raise the resolution and the pixels of two rows are interlacing with each other in accordance.

In addition, the present invention provides a line image sensor, having the features: the line image sensor is formed by a plurality of pixels being arranged in two parallel rows to raise the resolution, and the pixel arranging structure of the two parallel rows are arranged closely, which the pixels of two parallel rows are interlacing with each other in accordance.

Another, the present invention provides a line image sensor, having the features: the line image sensor is formed by a plurality of pixels being arranged in a plurality of parallel rows to raise the resolution, and the pixels of the plurality parallel rows are arranged closely, which the pixels of the plurality parallel rows are interlacing with each other in accordance.

Wherein, the line image sensor can be fabricated using the technologies of Charge-Couple Device (CCD) or Complementary Metal-Oxide Semiconductor (CMOS).

Other objects, advantages, and novel features of the invention will become more apparent from the following detailed description when taken in conjunction with the accompanying drawings.

### BRIEF DESCRIPTION OF THE DRAWINGS

FIG. 1 is the view of the layout of the conventional line image sensor;

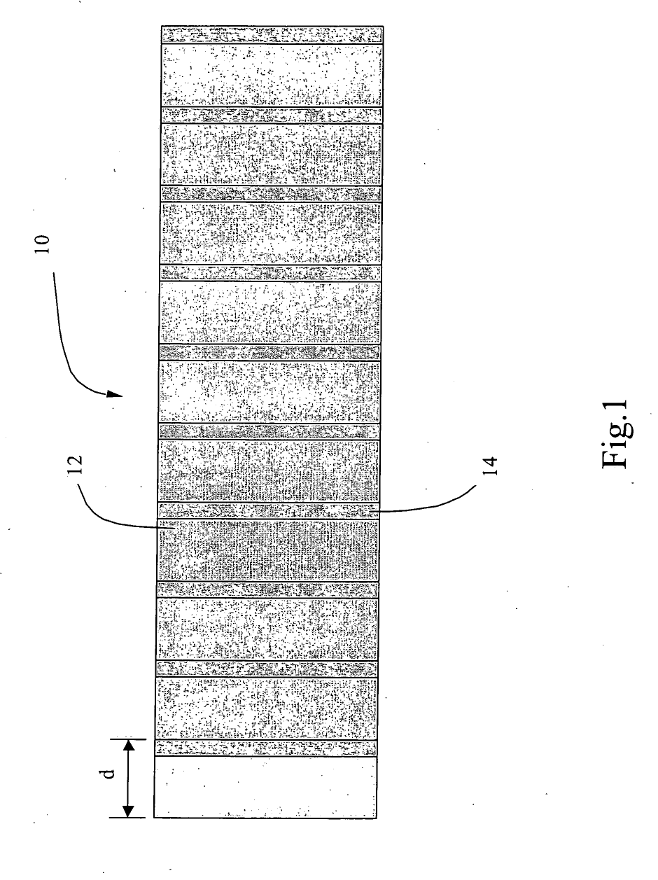

FIG. 2 is view of the first embodiment of the line image sensor of the present invention;

FIG. 3 is view of the second embodiment of the line image sensor of the present invention; and

FIG. 4 is view of the third embodiment of the line image sensor of the present invention.

### DETAILED DESCRIPTION OF THE PREFERRED EMBODIMENT

The largest occupying area in the layout of the image sensor is the sensor part, namely, the most pixel area is occupied by the sensor part. Other devices such as readout circuit, amplifier and analog to digital converter (ADC) have different layout method according to the types of the sensors. Therefore, the main goal of the present invention focuses on the layout of the sensor part among the pixels.

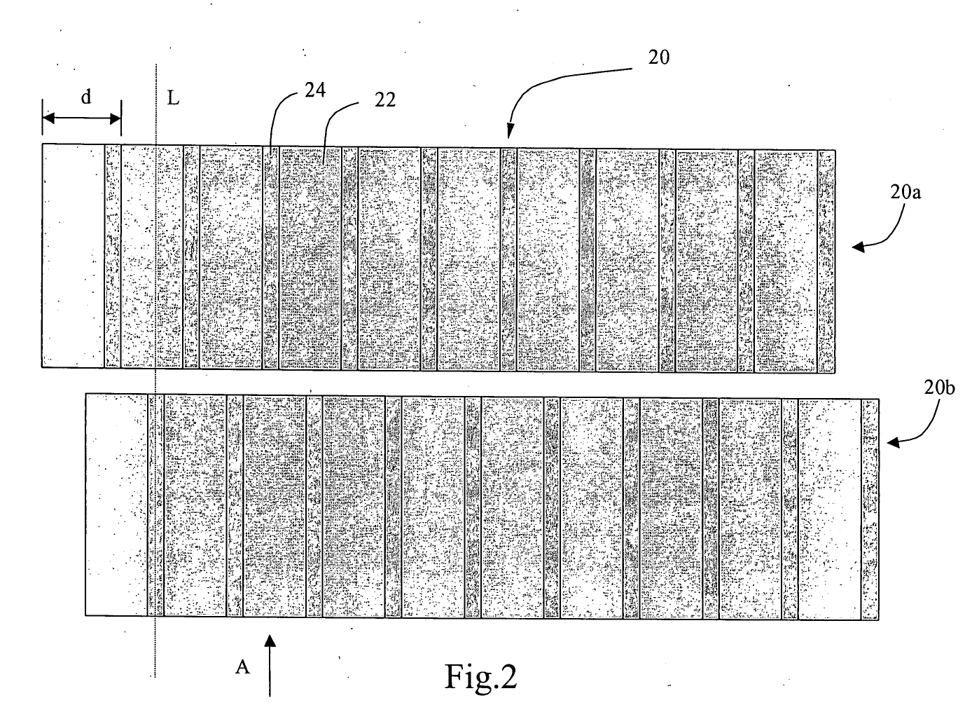

Please refer to FIG. 2, showing the view of the first embodiment of the line image sensor of the present invention. For achieving the goal of the higher resolution at the same technology, the present invention uses the interlacing pixel arranging structure to obtain the image information of high resolution in a smaller area.

It can be seen clearly from FIG. 2 that the pixels of line image sensor 20 are divided into two rows, namely, the first pixel row 20a and the second pixel row 20b. The first pixel row 20a and the second pixel row 20b are interlacing with each other. The numbers of the pixel seen from the direction “A” are the sums of the pixels of the first pixel row 20a and the second pixel row 20b, namely, the pixels are arranged in sequence. Therefore, the best condition in the design is that the center of each pixel of the first pixel row 20a or of the second pixel row 20b respectively collimates to the gap center of the opposite pixel row, as shown in dotted line L. Practically, some suitable deviation is allowable in the design.

Accordingly, at the same condition such as the constant pixel width “d”, the constant pixel size 22 and gap 24 (equals to the gap 14), the present invention obtains higher resolution comparing to the same length of the sensor of the prior art. For example, the resolution using the present invention is 1024 points when using 512 points both in the upper and lower place. In another word, the sensor length of the present invention just needs half of the conventional design as the pixels are 1024.

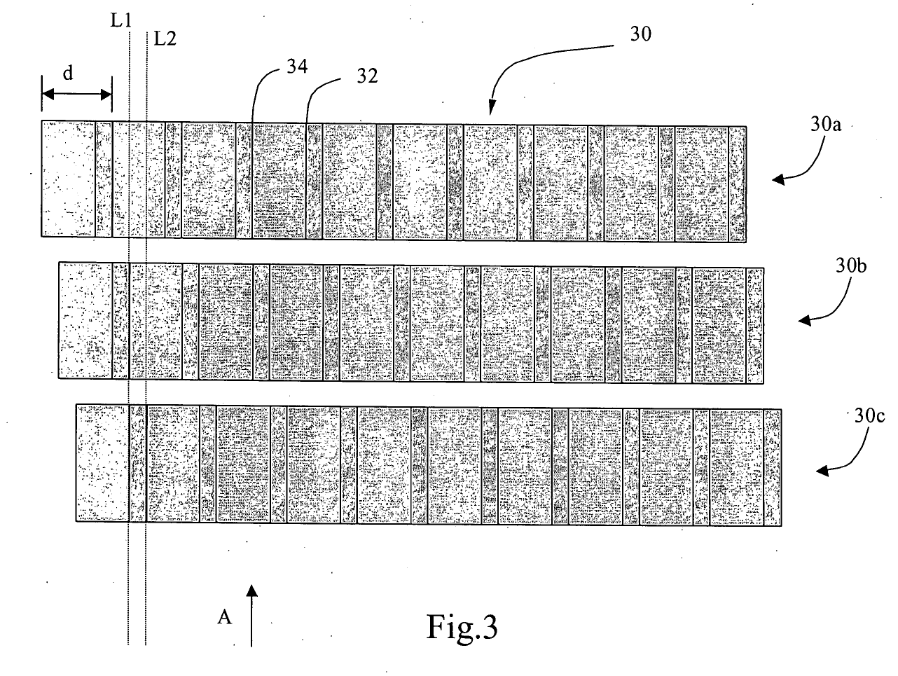

Please refer to FIG. 3, showing the view of the second embodiment of the line image sensor of the present invention. It can be seen clearly from FIG. 3 that the pixels of line image sensor 30 are divided into three rows, namely, the first pixel row 30a, the second pixel row 30b and the third pixel row 30c. The pixels of the first pixel row 30a, the second pixel row 30b and the third pixel row 30c are interlacing with each other. The numbers of the pixel seen from the direction “A” are the sums of the pixels of the first pixel row 30a, the second pixel row 30b and the third pixel row 30c, namely, the pixels are arranged in sequence. Therefore, the best condition in the design is that the edge of each pixel of the second pixel row 30b and the third pixel row 30c respectively collimate to, ⅓ position and ⅔ position of the pixel width of the first pixel row 30a in the design, as shown in dotted line L1 and L2. Practically, some suitable deviation is allowable in the design.

Accordingly, at the same condition such as the constant pixel width “d”, the constant pixel size 32 and gap 34 (equals to the gap 14), the present invention obtains higher resolution comparing to the same length of the sensor of the prior art. For example, the resolution using the present invention is 1536 points as the 512 points in the upper, middle and lower place. In another word, the sensor of the present invention just needs the ⅓ length of the conventional design as the pixels are 1536.

In fact, the goal of the line image sensor of high resolution can be obtained by using the multi-rows structure at the same concept. For example, four rows or five rows etc. are allowable according to the image resolution requirement of the designer or the specifications of the line sensor. On the condition of the multi-rows, each pixel is arranged in sequence and seen in the direction as a line to fit the sensing application of the line sensor.

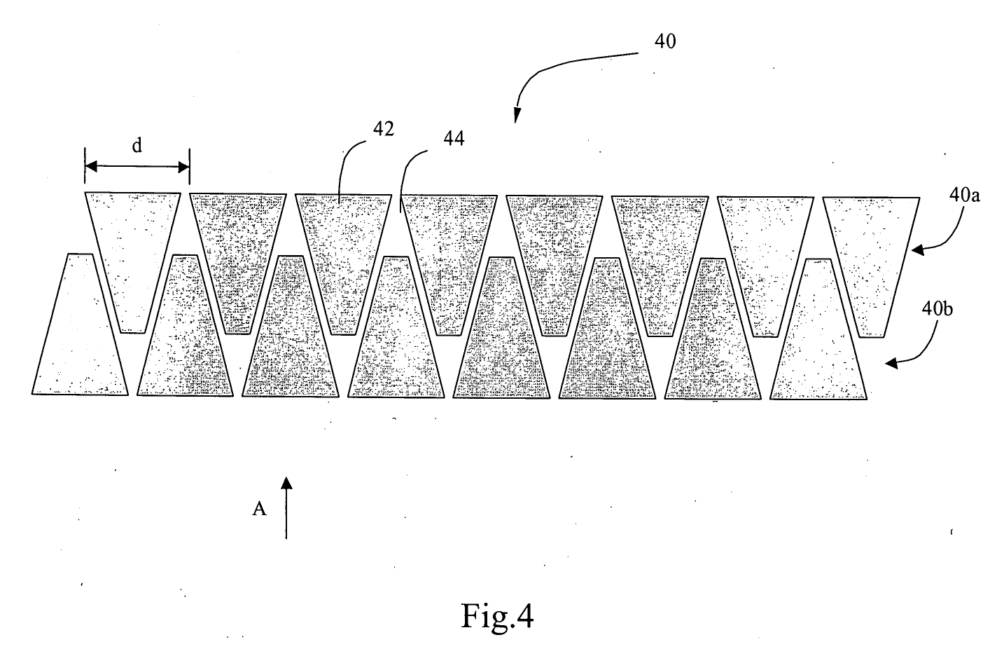

In addition, there are still different types of layout to be developed by using the same concept, excepting the parallel and close arranging structure. Please refer to FIG. 4, showing the view of the third embodiment of the line image sensor of the present invention. The pixels of line image sensor 40 are divided into two rows, namely, the first pixel row 40a and the second pixel row 40b. The pixels of the first pixel row 40a and the second pixel row 40b are interlacing with each other. The different between the embodiments above is that the pixels of the first pixel row 40a and the second pixel row 40b are not only interlacing with other but also alternating. Therefore, the space is saved and the two staggering rows are more like a “line”. Similarly, the numbers of the pixel seen from the direction “A” are the sums of the pixels of the first pixel row 40a and the second pixel row 40b. The embodiment can be expanded to the condition of multi-rows, for example, four rows and eight rows etc. The design principle is that the numbers of the pixels seen from the direction “A” are the sums of the pixels of each row, namely, the pixels are arranged in sequence.

Accordingly, at the same condition such as the constant pixel width d, the constant pixel size 42 and gap 44 (equals to the gap 14), the present invention obtains higher resolution comparing to the same length of the sensor of the prior art. For example, the resolutions using the present invention are 1024 points as the 512 points in the upper and lower place. In another word, the sensor of the present invention just needs ½ length of the conventional design as the pixels are 1024.

By using the technology of the present invention, the line image sensor having the same sizes of the pixels can obtain higher resolution, or the line image sensor having the same numbers of the pixels can reduce the length of the sensor to further raise the yield rate.

Although the invention has been explained in relation to its preferred embodiment, it is to be understood that many other possible modifications and variations can be made without departing from the spirit and scope of the invention as hereinafter claimed.

What is claimed is:

1. A pixel layout for a line image sensor, wherein the improvement comprises, said line image sensor is formed by a plurality of pixels being arranged in two pixel rows to raise the resolution, and said two pixel rows are interlacing by pixels in accordance.

2. The pixel layout for a line image sensor of claim 1, wherein said two pixel rows are arranged in parallel.

3. The pixel layout for a line image sensor of claim 1, wherein said two pixel rows are arranged in parallel and each pixel in one row is alternating with other two pixels in another row.

4. The pixel layout for a line image sensor of claim 1, wherein said line image sensor is fabricated by the technology of Charge-Couple Device (CCD).

5. The pixel layout for a line image sensor of claim 1, wherein said line image sensor is fabricated by the technology of Complementary Metal-Oxide Semiconductor (CMOS).

6. A pixel layout for a line image sensor, wherein the improvement comprises, said line image sensor is formed by a plurality of pixels being arranged in more than even pixel rows to raise the resolution, and pixels of said more than even pixel rows are interlacing with each other.

7. The pixel layout for a line image sensor of claim 6, wherein said more than even pixel rows are arranged in parallel.

8. The pixel layout for a line image sensor of claim 6, wherein said more than even pixel rows are arranged in parallel and each pixel of one row is alternating with other two pixels of adjacent row.

9. The pixel layout for a line image sensor of claim 6, wherein said line image sensor is fabricated by the technology of Charge-Couple Device (CCD).

10. The pixel layout for a line image sensor of claim 6, wherein said line image sensor is fabricated by the technology of Complementary Metal-Oxide Semiconductor (CMOS).

11. A pixel layout for a line image sensor, wherein the improvement comprises, the line image sensor is formed by a plurality of pixels being arranged in a plurality parallel rows to raise the resolution, and said more than two parallel rows are arranged closely, which pixels of said plurality parallel rows are interlacing with each other in accordance.

12. The pixel layout for a line image sensor of claim 11, wherein said line image sensor is fabricated by the technology of Charge-Couple Device (CCD).

13. The pixel layout for a line, image sensor of claim 11, wherein said line image sensor is fabricated by the technology of Complementary Metal-Oxide Semiconductor (CMOs).
